(19) United States
(12) Patent Application Publication
(10) Pub. No.: US 2006/0040077 A1
(43) Pub. Date: Feb. 23, 2006

(54) Method for forming a reinforcement for a resilient wheel and a reinforcement for a resilient wheel

(76) Inventors: Brian D. Wilson, Greer, SC (US); Metodi L. Ikonomov, Moore, SC (US)

Correspondence Address: Alan A. Csontos;Michelin North America, Inc., Intellectual Property Department, P.O. Box 2026, Greenville, SC, 29602, US

(21) Appl. No.: 10/922,004

(22) Filed: Aug. 19, 2004

(51) Int. Cl. B65H 81/00; B32B 1/08

(52) U.S. Cl. 428/36.9; 156/172; 156/173; 156/273.9

(57) ABSTRACT

A process for forming a reinforcement for a resilient, structurally supported wheel includes the steps of placing a supporting member, such as a stay, on a cylindrically shaped mandrel, winding a reinforcing wire on the mandrel over the supporting member while heating the wire to embed the wire in the supporting member, wherein, upon cooling, the wire is bonded to and supported by the supporting member to maintain a cylindrical shape

### BACKGROUND AND SUMMARY OF THE INVENTION

The invention relates to structural reinforcements for resilient wheels and wheel-tires, and in particular, to reinforcements for non-pneumatic tires that are formed by molding processes. More particularly, the invention is directed to a method for forming a wire reinforcement for a non-pneumatic resilient wheel-tire that is self-supporting, which allows the reinforcement to be made independent of the tire forming process.

U.S. application Ser. No. 10/618,924, owned in common with the present application, discloses a non-pneumatic resilient wheel-tire having a deformable, load supporting ring and a plurality of webs connecting the ring to a hub. The webs act in tension to transmit the load on the ring to the hub, which is similar to the load supporting and transmitting mechanism of a pneumatic tire. The ring is capable of deforming on the ground contact surface, which provides the tire the ability to transmit traction and steering forces similar to a pneumatic tire. The ring includes a support ply embedded in the ring to control the deformation of the ring when loaded. According to one embodiment, the support ply is a cylindrical wire coil.

A non-pneumatic tire as described in the aforementioned application may be made in a molding process, in which the ring and webs are formed of the same material injected or caused to flow into a mold. In such a process, a difficulty arises in forming the support ply and correctly positioning it in a mold for the non-pneumatic tire. It would be convenient to form the support ply in a separate step, and insert and position it in the mold before the ring and web material is injected.

The invention provides a method for forming a wire reinforcement structure that is self-supporting and allows the reinforcement structure to be made separate from the tire itself, for example, at a more convenient time, and inserted in the tire mold.

According to the invention, a wire support structure is formed on a mandrel, and the method includes the steps of placing a supporting member on a cylindrically shaped mandrel, winding a reinforcing wire on the mandrel over the supporting member while heating the wire to embed the wire in the supporting member, wherein, upon cooling, the wire is bonded to and supported by the supporting member to maintain a cylindrical shape.

The wire may be heated by resistance heating, inductance heating, or another convenient method.

According to one embodiment of the invention, the supporting member comprises a sheet of plastic material wrapped on the mandrel. According to a preferred embodiment, the supporting member comprises at least two plastic stays or ties placed on the mandrel. In accordance with a more preferred embodiment, the supporting member includes three plastic stays, which are disposed so that respective free ends extend from an end of the wire coil to provide positioning spacers for correctly positioning the supporting member in a mold for making a resilient wheel-tire.

According to the invention, the step of placing the plastic ties includes placing the ties in equally spaced relation on the mandrel.

The method according to the invention further comprises the step of providing a mandrel having grooves for accepting the plastic ties.

According to another aspect of the invention, the method includes the step of applying an adhesive to at least one of the supporting member and the at least two plastic ties, wherein the step of heating the wire activates the adhesive. According to a further embodiment, the adhesive is a UV cured adhesive and includes the step of applying UV energy to the coated wire to activate the adhesive.

### BRIEF DESCRIPTION OF THE DRAWINGS

The invention will be better understood by reference to the following detailed description in conjunction with the appended drawings, in which:

FIG. 1 is a perspective view of a wire coil reinforcement in accordance with the invention;

FIG. 2 is a perspective view of a wire coil reinforcement according to an alternative embodiment of the invention; and,

FIG. 3 is a schematic view of an illustrative apparatus for making the wire coil reinforcement of FIG. 2.

### DETAILED DESCRIPTION

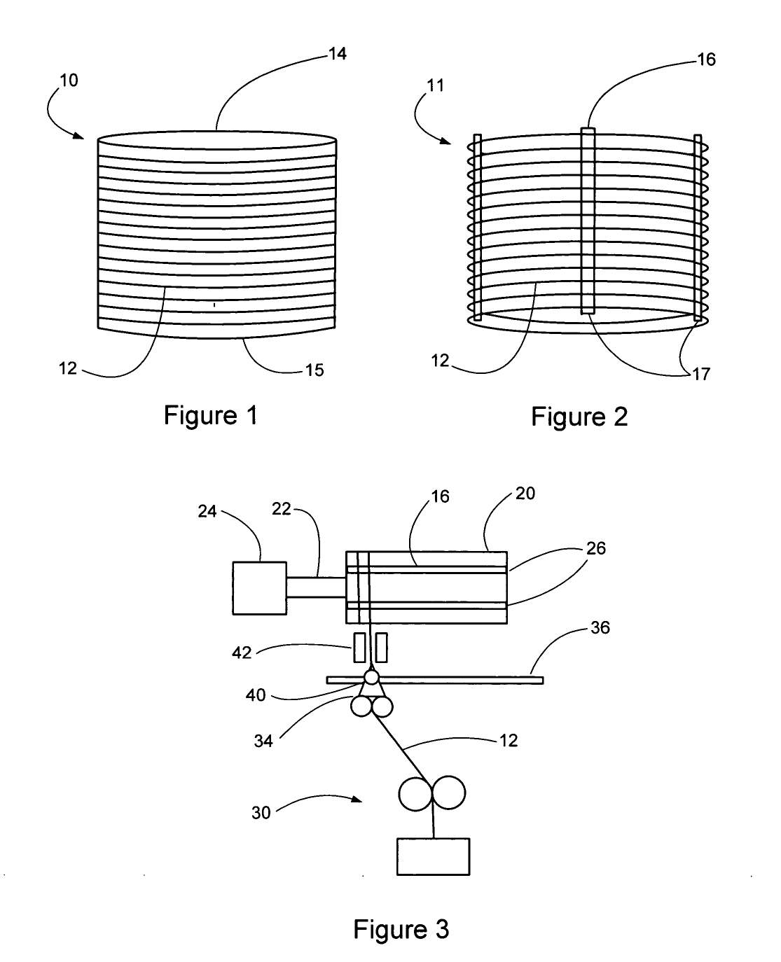

A wire coil reinforcement 10 for a tire is shown in FIG. 1. The reinforcement 10 is intended to be embedded in the outer supporting band of a non-pneumatic tire of the type described in commonly owned US patent application Ser. No. 10/618,924, the disclosure of which is incorporated herein by reference. The wire coil reinforcement 10 of the present invention is useful in other tire constructions or tire-like structures, as will be apparent to those skilled in the art, and the description here is meant to be illustrative, rather than limiting.

FIG. 1 shows a wire coil 12 wrapped on a supporting member 14, which in the illustrated embodiment is a sheet of plastic material. The wire coil 12 and supporting member 14 are formed in a cylindrical shape, and are intended to be embedded in an outer ring of a resilient wheel tire as described in the aforementioned US patent application.

FIG. 2 shows an alternative, preferred embodiment of the wire coil reinforcement, in which the supporting member comprises a plurality of plastic stays or ties 16. The supporting member sheet 14 and stays 16 help maintain the wire coil in the cylindrical shape so that the wire reinforcement may be readily handled and placed in a mold for forming the wheel tire. An outer edge 15 of the sheet 14 and the free ends 17 of the stays 16 extend beyond the last turn of the wire coil 12, and are disposed to provide a level base for accurately positioning the supporting member in a mold.

FIG. 2 has been simplified for clarity by illustrating only a front of the coil and omitting illustration of rear portion of the wire turns. At least one, and preferably a plurality of, stays or ties 14 supports the wire 12 in the cylindrical shape. Three stays 14 are illustrated in FIG. 1, although it should be understood that a fourth stay opposite the centrally positioned stay in FIG. 2 is omitted. According to one aspect of the invention, at least three stays 14 are needed to provide a base for the coil allowing it to stand with a central axis perpendicular to the supporting surface. This is useful in accurately positioning the coil in a mold.

The number and spacing of stays 16 is determined as that needed to provide the necessary or desired dimensional stability to the coil. A number of stays other than as shown may be used depending on the size of the coil and size of the wires used. The stays 14 are bonded to the wire 12, and the wire is preferably embedded in the stays. The stays 14 are narrow bars having a length preferably greater than the axial length of the wire coil to provide the base described above, and having a thickness sufficiently greater that the thickness of the wire 12 to allow the wire to become embedded in the stay.

The supporting member sheet 14 or stays 14 are advantageously formed of a material that is compatible with the material of the supporting band of such a tire to facilitate bonding and integrating in the load supporting band of a resilient wheel tire. In such a case, an adhesive or bonding agent may be applied to the stays 14 during the process for forming the supporting band. A heat-activated adhesive could be applied to the wire, and activated during the heating step. Preferably, the sheet 14 or stays 16 are formed of the same material as the load supporting band of the wheel, which facilitates bonding to the band and ensures that that the material properties of the stays are compatible with the supporting band material.

The wire 12 is formed to have sufficient tensile strength to perform the supporting function. Advantageously, steel cord used in tire tread belts has been found to be useful. Steel cord may be coated or treated to facilitate bonding with the material of the stay and the supporting band, as will be appreciated by those skilled in the art. The diameter of the wire may be selected according to the tensile properties needed for the particular wheel.

FIG. 3 illustrates schematically an apparatus for forming a wire reinforcement of the type shown in FIG. 2 in accordance with the invention. Those of skill in the art will understand that a supporting sheet 14 may be substituted for the stays 16 described below. The apparatus includes a mandrel 20 attached by a shaft 22 to a motor 24. The mandrel 20 surface includes grooves 26 formed in the axial direction of the mandrel for retaining the stays during the winding process.

A wire supply reel 30 fees wire to a distributor 34 which travels on a reciprocating drive 36 to place the wire 12 on the mandrel with appropriate tension and pacing.

According to one embodiment, an electric contact 40 on wire supply 30 provides electric current to the wire 12 during the winding process. The mandrel 20 has an electrically conductive surface, and the wire 12 wound in contact with the mandrel shorts the electric current, thus allowing current to flow between the contact 40 and the mandrel. Resistance in the wire 12 causes it to heat and embed into the plastic stays 16. When the winding process is complete, the wire 12 and stays 16 are allowed to cool, which bonds the wire to the stays.

Alternatively, other heating means could be provided, for example, an inductive heater 42 can heat the wire immediately prior to it being laid on the mandrel. Other heating means could be used.

Heating the wire is preferred as a way to control the resultant heating of the stays or sheet to be sufficient for embedding the wire, but not causing other change to the stays or sheet, for example, allowing the wire to cut through the stay or sheet, or causing a change in shape of the stay or sheet.

The formed coil 10 may then be removed from the mandrel 20. To facilitate removal, a collapsible mandrel may be provided. The coil 10 is self-supporting, and may conveniently be stored or held until needed for the tire molding process. The coil 10 may also be conveniently handled, in particular, when placing in a mold.

What is claimed is:

1. A method for forming a wire reinforcement structure for a tire, comprising the steps of:
placing a plastic supporting member on a form;
winding a reinforcing wire on the form over the plastic supporting member to form a cylindrically shaped structure;
applying energy to the wire to bond the wire to the plastic supporting member; and,
allowing the wire and plastic to bond so that the plastic supporting member supports the wire in the cylindrically shaped structure.

2. The method according to claim 1, wherein the step of placing a supporting member on a form comprises placing in an axial direction at least one plastic stay on the form.

3. The method according to claim 2, further comprising the step of providing a form having grooves for accepting the at least one plastic stay.

4. The method according to claim 2, wherein the step of placing the at least one plastic stay on the form comprises placing a plurality of stays in equally spaced relation about the circumference of the form.

5. The method according to claim 1, wherein the step of placing a supporting member on a form comprises placing a sheet of plastic material on the mandrel.

6. The method according to claim 1, wherein the step of applying energy includes heating the wire sufficiently to soften the plastic supporting member to allow the wire to embed in the member.

7. The method according to claim 6, wherein the wire is heated before being wound on the form.

8. The method according to claim 1, further comprising the step of applying an adhesive to one of the wire and the plastic supporting member, and wherein the step of applying energy comprises one of applying UV energy and heat to activate the adhesive.

9. A wire coil reinforcement for a resilient wheel tire, comprising:
a wound wire coil; and,
at least one plastic supporting member extending in an axial direction of the wire coil, wherein, the wire coil is embedded in the at least one plastic support member.

10. The wire coil reinforcement as claimed in claim 1, wherein the at least one plastic supporting member comprises a stay.

11. The wire coil reinforcement as claimed in claim 9, wherein the at least one plastic supporting member comprises a sheet of plastic material.
